(19) United States
(12) Patent Application Publication
(10) Pub. No.: US 2002/0182357 A1
(43) Pub. Date: Dec. 5, 2002

(54) Metal tubing coated with foamed polymeric materials

(75) Inventors: Dennis C. Soles, Rochester Hills, MI (US); Henry S. Hsich, Rochester Hills, MI (US); Greg Scarrow, Marysville, MI (US)

Correspondence Address: Jenner & Block, 330 N. Wabash Avenue, Chicago, IL, 60611, US

(73) Assignee: TI Group Automotive Systems, LLC

(21) Appl. No.: 10/159,742

(22) Filed: May 31, 2002

Related U.S. Application Data
(63) Continuation-in-part of application No. 08/382,915, filed on Feb. 3, 1995, now abandoned.
Application No. 08/382,915 is a continuation-in-part of application No. 09/370,424, filed on Aug. 9, 1999.
Application No. 09/370,424 is a continuation of application No. 08/806,232, filed on Feb. 24, 1997, now Pat. No. 5,972,450.
Application No. 08/806,232 is a continuation-in-part of application No. 08/541,855, filed on Oct. 10, 1995, now abandoned.

(51) Int. Cl. B32B 1/08; B29C 44/32

(52) U.S. Cl. 428/36.91; 264/45.9; 264/46.7; 264/50; 264/51; 264/171.12; 264/171.18

(57) ABSTRACT

A coated metal tubing arrangement having a metal tube, a first layer of a first polymeric material and a second layer of a second polymeric material having a foamed structure. The second layer is located directly radially outwardly of the first layer. The second polymeric material is chemically similar to the first polymeric material.

This is a continuation-in-part of U.S. patent application Ser. No. 08/382,915, filed on Aug. 25, 1999, which is a continuation-in-part of U.S. patent application Ser. No. 09/370,424, filed on Aug. 9, 1999, which is a continuation of U.S. patent application Ser. No. 08/806,232, filed on Feb. 24, 1997, which is continuation-in-part of U.S. patent application Ser. No. 08/541,855, filed on Oct. 10, 1995.

### BACKGROUND OF THE INVENTION

This invention relates to metal tubing products, and more particularly, to metal tubing used in the automotive industry for applications such as brake lines, fuel lines and transmission oil cooling lines.

Tubing utilized in automotive applications requires corrosion and wear resistance that will allow it to last for the useful life of a vehicle. Also, the tubing must have abrasion resistance consistent with an automotive environment (i.e. stone impingement and chipping). Finally, the tubing should be able to isolate and absorb mechanical vibrations and acoustic noises. To satisfy these requirements, protective coating(s) are usually applied to metal tubing which is to be utilized in automotive applications.

Coatings used in the industry have generally been characterized by one or both of the following. First, a metallic substrate is deposited on the steel tube surface. Usually this is a sacrificial coating wherein the substrate corrodes before the metal tubing. Second, a barrier coating is deposited over the substrate to keep corrosive media from initiating corrosion and to provide increased abrasion resistance.

Examples of past materials and combinations of materials used as substrate and/or barrier layers in the automotive industry include: terne (an alloy of nominally 85% lead and 15% tin); zinc-rich paint over terne; a zinc-aluminum alloy (consisting of 95% zinc and 5% aluminum—available under the trademark GALFAN); aluminum rich paint over a GALFAN coating; electroplated zinc or zinc-nickel; PVF or PVDF over electroplated zinc; hot dip aluminum; epoxy and nylon.

These materials have been used as barrier and/or substrate layers in various combinations, but have experienced shortcomings that limit their usefulness. Prior art coating materials and methods have exhibited only limited resistance to wear and chipping from stone impingement and abrasion. Often, a shrinkable thermoplastic jacket is applied around conventionally coated tubes in order to provide improved chipping and wear resistance. Such methods, however, are very expensive and are not always effective. For example, shrinkable plastic jackets have only limited ability for absorbing or isolating mechanical vibrations and acoustic noises. Also, use of shrinkable plastic jackets is problematic in that the relatively high thickness of the jacket precludes its use under end fittings or connectors, thereby exposing the tube end to corrosion.

In order to overcome all of the problems (i.e. corrosion, wear, abrasion, chipping, stone-impingement, mechanical vibration, acoustic noise) encountered in automotive and fluid transport tubing applications simultaneously, specific polymer properties must be tailored for a tube coating. Since no single polymeric material is effective in combatting all problems, an effective product will take into account the relationship of polymer structures and properties as well as material processing and engineering application considerations.

Accordingly, the present invention provides a unique multi-layer polymer coating on metal tubing which manipulates the dynamic mechanical properties of polymeric materials to achieve protection against multiple elements for metal tubing used in automotive or fluid transport applications. It combines the unique dynamic mechanical properties of two layers of polymers to provide maximum effectiveness in corrosion resistance and wear, abrasion, chipping and stone impingement protection. Moreover, the multi-layer coating of the present invention is effective at absorbing impact energy and eliminating mechanical vibration and acoustic noises.

### SUMMARY OF THE INVENTION

The present invention provides a coated metal tubing arrangement having a metal tube, a first layer of a first polymeric material and a second layer of a second polymeric material having a foamed structure. The second layer is located directly radially outwardly of the first layer. The second polymeric material is chemically similar to the first polymeric material.

### BRIEF DESCRIPTION OF THE DRAWINGS

FIG. 1 is a sectional view of a portion of a coated metal tubing arrangement according to the present invention; and

FIG. 2 is a sectional view of the tubing arrangement of FIG. 1 having one end stripped to facilitate connection to end fittings.

### DETAILED DESCRIPTION OF THE INVENTION

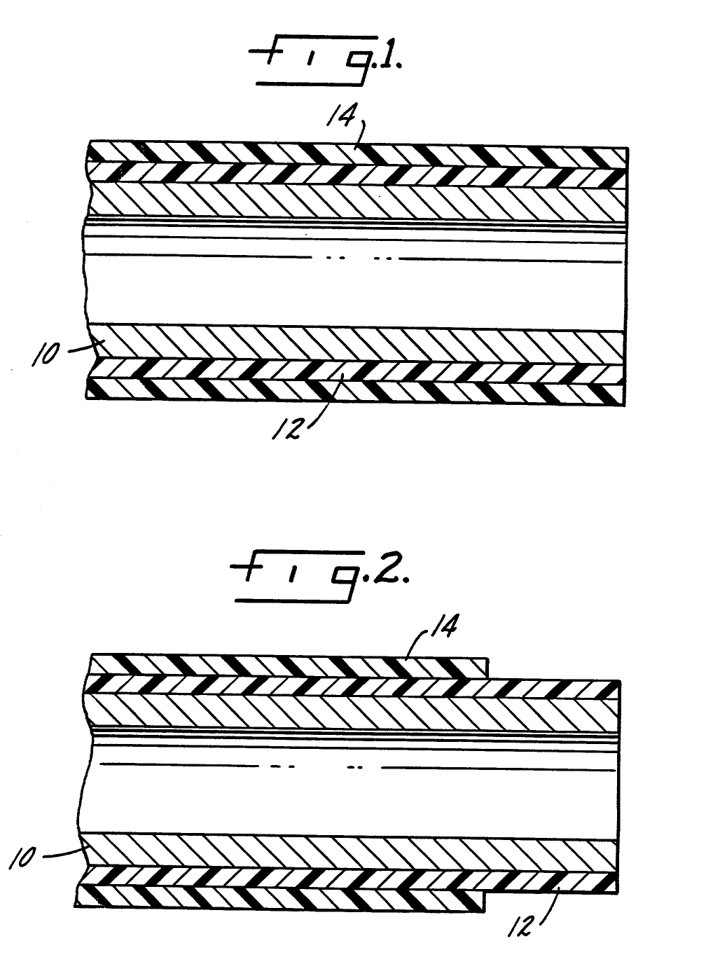

FIG. 1 illustrates a metal tube 10 coated according to the present invention. Tube 10 is coated by an inner layer 12 of a first polymeric material and an outer layer 14 of a second polymeric material. Inner layer 12 is bonded to metal tube 10 and outer layer 14 is extruded around inner layer 12. Layers 12 and 14 are not bonded together through use of an adhesive or any other bonding method. This is advantageous as it permits outer layer 14 to be stripped at the ends of tube 10 (FIG. 2), which facilitates connection to end fittings or connectors.

Numerous considerations are involved in choosing the particular polymer materials or blends which will comprise layers 12 and 14. The inner layer polymer must provide chemical resistance and prevent corrosion of metal tube 10. The outer layer polymer must absorb impact energy as well as eliminate mechanical vibration and acoustic noises. The outer layer polymer should also be amenable to easy stripping or removal for end fittings or connections.

The specific properties and structural attributes of particular polymers must be taken into account in order to achieve these results. For the inner layer polymer to have good chemical resistance, for example, it must have a high crystallinity. High crystallinity, however, decreases the ability of a polymer to absorb impact energy and to isolate mechanical vibrations and acoustic noises. This function is provided by the outer layer polymer.

Dynamic mechanical properties are the key in determining the ability of the outer layer polymer to eliminate mechanical vibrations and acoustic noises. These dynamic mechanical properties are briefly described below:

The modulus of a polymer is a function of temperature and frequency, ω, at measurement. The dampening factor of a polymer, tan δw, is the ratio of the imaginary part of the modulus, G″w over the real part of the modulus, G′w (the storage modulus). The natural frequency, ωo, is the lowest noise frequency which can be eliminated by the mechanical system. The natural frequency, ωo, and the transmissibility, T, of a mechanical system can be expressed as a function of dynamic mechanical properties of polymers as follows:

$${ω}_{o} = {[ \frac{K {G}_{o}^{′}}{M} ]}^{1 / 2}$$

$$and$$

$$T = {[ \frac{1 + {tan}^{2} {δ}_{w}}{{( 1 - ( {ω}^{2} / {ω}_{o} ) ( {G}_{o}^{′} / {G}_{w}^{′} ) )}^{2} + {tan}^{2} {δ}_{w}} ]}^{1 / 2}$$

where K is a shape factor, M is the mass of the system, G′o and G′w are the shear storage moduli of the polymer at natural frequency ωo and forced frequency ω, respectively, tan δw is a measure of polymer dampening at the forced frequency, and T is the transmissibility of the mechanical system.

Both dynamic modulus and dampening are functions of temperature and frequency. These mechanical properties can be manipulated by tailoring the molecular structures of polymers. To that end, one can achieve a low natural-frequency vibration system by reducing the storage modulus of the polymer in question. In addition, one can suppress the resonant transmissibility by choosing polymers with high dampening factors.

Inner layer 12, as stated above, is comprised of a polymeric material which is chosen for its chemical and liquid resistance. Layer 12 is bonded to the underlying metal tube 10 and keeps corrosive media from reaching or attacking tube 10. The polymeric material chosen for layer 12 should be particularly resistant to corrosive media or fluids commonly encountered in automotive applications, such as brake fluid, engine oil and fuel.

To achieve these ends, the polymeric material of inner layer 12 must have high crystallinity and a low dampening factor. The dampening factor is the ratio of the imaginary part of the storage modulus over the real part of the modulus and, for inner layer 12, is preferably less than 0.05. The polymeric material of inner layer 12 should also have a flexural modulus of at least 100 MPa.

Suitable polymeric materials for inner layer 12 include, but are not limited to, polyamides (nylons), polyimides, polyesters, fluoroplastics (such as polyvinyl fluoride or polyvinylidene fluoride), epoxies, polyphenylene sulfides, polyacetals, phenolic resins, polyketones, polyolefins and polyvinyl chloride.

Outer layer 14 is comprised of a polymeric material which is extruded around inner layer 12. Layer 14 is unbonded, or weakly bonded, to inner layer 12. It is complementary to inner layer 12 in that, while inner layer 12 provides protection against chemicals and corrosive liquids, outer layer 14 provides resistance to chipping and wear from stone impingement and abrasion. Outer layer 14 is also responsible for absorbing impact energy as well as eliminating mechanical vibration and acoustic noises. Heat insulation and thermal protection are also provided by layer 14.

Outer layer 14 may be comprised of a single-phase polymeric material selected from the same group as layer 12, or it may be comprised of a multi-phase polymer.

The term “multi-phase” indicates that the material is a blend or copolymer of two or more polymers. By being comprised of two or more polymer components, the outer layer polymeric material can be tailored with specific dampening characteristics (natural frequency and transmissibility) to isolate or absorb forced frequencies of mechanical vibrations and acoustic noise.

The multi-phase polymer has at least two glass transition temperatures in which their morphology and property can be manipulated by a thermodynamic process to create the desired damping characteristic. This concept of morphology control through a thermodynamic process to create the desired damping characteristic is described in the inventor's prior art publications, “Morphology and Property Control via Phase Separation or Phase Dissolution during Cure in Multiphase Systems”, Advances in Polymer Technology, Vol. 10, No. 3, pp. 185-203 (1990); H. S. -Y. Hsich, Proc. 34^{th} Int. SAMPE Symp., 884 (1989); H. S. -Y. Hsich, J. Mater. Sci., 25, 1568 (1990); and H. S. -Y. Hsich, Polym. Eng. Sci., 30, 493 (1990).

The multi-phase polymer for forming the outer layer 14 has a high dampening factor of at least 0.05. Preferably, the dampening factor is between 0.1 and 0.3 in an application temperature range between −50 and 150 degrees Celsius. This high dampening factor provides for more dissipation of impact energy than does the lower dampening factor of the inner layer. The flexural modulus of the outer layer polymer should be lower than 50 MPa. A lower flexural modulus means that the polymeric material is less stiff (more flexible) than the polymer of the inner layer. The wall thickness of outer layer 14 should be greater than 50 microns. The preferred wall thickness is between 200 and 500 microns.

Use of a multi-phase polymer having at least two different polymer components is advantageous in that each component will have a distinct glass-transition temperature. At temperatures near the glass-transition temperature of a polymer, the polymer has a very high dampening factor. Providing a multi-phase polymer with multiple glass-transition temperatures, therefore, will provide high dampening factors over a wide temperature range and, consequently, will provide the best ability to eliminate mechanical vibrations and acoustic noises under engineering service environments.

Preferably, at least one of the polymer components of the outer layer will have a glass-transition temperature below room temperature (22 degrees Celsius) and the other polymer component will have a melting point above 100 degrees Celsius. It is also preferred that one polymer component be a rubbery phase and the other component be a thermoplastic phase.

Outer layer 14 also have a high degree of heat resistance. Heat reflective fillers may be added to the polymeric material of layer 14 to enhance heat resistance.

Suitable multi-phase polymeric materials for outer layer 14 include, but are not limited to, copolymers or polymer blends (or alloys) of polyamides, polyesters, polyolefins, polyurethane and polyvinyl chloride. Thermoplastic polyolefin (TPO) is a specific example of a suitable polymer blend.

Prior to application of layers 12 and 14 over metal tube 10, tube 10 may be surface treated with a substrate to further enhance corrosion resistance. Suitable materials for surface treatment of tube 10 include chromate, phosphate, zinc, aluminum-rich paint, zinc-aluminum substrates, zinc-nickel substrates or a mixture of these materials. This will further enhance corrosion-resistance.

Together, the unique dynamic mechanical properties of layers 12 and 14 combine to provide outstanding performance and to achieve multiple protections for metal tubing used in automotive or fluid transport applications. Inner layer 12 provides protection against harmful chemicals and corrosive liquids, while outer layer 14 provides resistance against wear, abrasion, chipping and stone impingement, absorbs impact energy, and isolates or absorbs mechanical vibrations and acoustic noises.

The polymeric material for forming the outer layer may have a non-foamed structure or a foamed structure. A foamed polymer offers the tubing assembly the same degree of strengths as a non-foamed multiphase polymer, yet the usage of foamed multiphase polymer for forming the outer layer significantly reduces the weight of the tubing compared to the non-foamed multiphase polymer. This reduction is weight is due to the presence of void spaces in the polymer formed during the foaming process. Furthermore, a layer of foamed polymer is able to provide better thermo-insulation than a layer of non-foamed polymer.

The foaming of the polymer is caused by the addition of a blowing agent into the polymer for forming the outer layer. Examples of such blowing agents include but are not limited to azodicarbonamides, hydrazine derivatives, semi-carbazides, tetrazoles, benzoxazines and mixtures thereof. The blowing agent is mixed with the polymer for forming the outer layer just prior to the extrusion process. Following the extrusion of the outer layer, the blowing agent will cause the polymer to expand or foam, thus creating void spaces within the outer layer.

An alternative embodiment of a coated metal tube of the present invention is a metal tube coated by a single outer layer of polymeric material. The outer layer of polymeric material is extruded onto the tube.

The outer layer may be comprised of a single-phase polymeric material, or it may be comprised of a multi-phase polymer.

Suitable single-phase polymeric material for forming the outer layer are the same as those identified for the outer layer in the embodiment having two layers of polymeric materials. Suitable multi-phase polymers for forming the outer layer are the same as those identified for the outer layer in the embodiment having two layers of polymeric materials.

The outer layer of the alternative embodiment is able to provide protection against harmful chemicals and corrosive liquids. It is also able to dissipate impact energy to improve chipping, wear resistance and isolates or absorbs mechanical vibrations and acoustic noises.

The polymeric material for forming the outer layer of the alternative embodiment may have a non-foamed structure or a foamed structure. The process for foaming the polymeric material of the alternative embodiment is same as the process disclosed in the embodiment having two layers of polymeric material.

Another alternative embodiment of the present invention is a metal tube coated by a first layer of a non-foamed polymeric material and a second layer of a foamed polymeric material in which the non-foamed polymeric material and the foamed polymeric material are chemically similar materials. Chemically similar materials are defined for the purpose of this embodiment as the non-foamed polymeric material and the foamed polymeric material comprising the same material, with the exception of the foamed material including additional blowing agents to expanding the foamed material or the injection of a gas, such as nitrogen, to expanded the foamed material. The use of chemically similar materials for forming the first layer and the second layer allows the non-foamed polymeric material to be miscible with the foamed polymeric material. This miscibility interaction of the non-foamed polymeric material with the foamed polymeric material eliminates the need for an adhesive layer to bond the first layer to the second layer or the need to select polymeric materials for the first and second layers which exhibit an affinity to each other.

Suitable polymeric material include, but are not limited to, polyamides, polyesters, polyolefins, polyurethane, polyethylene and polyvinyl chloride and mixtures thereof.

Examples of blowing agents added to the polymeric material include, but are not limited, to azodicarbonamides, hydrazine derivatives, semi-carbazides, tetazoles, benzoxazines and mixtures thereof. The blowing agent is mixed with the polymeric material just prior to the extrusion process.

Prior to extruding the first and second layers over the metal tube, the metal tube may be surface treated with a substrate to further enhance corrosion resistance. Suitable material for surface treatment of the tube include, but are not limited to, chromate, phosphate, zinc, aluminum-rich paint, zinc-aluminum substrates, zinc-nickel substrates and mixtures thereof.

The first and second layers can be co-extruded directly over the metal tubing or directly over the substrate if the metal tubing was treated with a substrate. Following the co-extrusion of first and second layers, the blowing agent in the foamed polymeric material will cause the foamed polymeric material of the second layer to expand or foam, thus creating void spaces within the second layer.

An additional third layer of a chemically similar non-foamed polymeric material can be extruded directly over the second layer. Since the second and third layers are chemically similar, the foamed polymeric material of the second layer is miscible with the non-foamed polymeric material of the third layer.

The third layer can be co-extruded with first and second layers. By co-extruding all three layers, the need for a separate extruder head for extruding the third layer is eliminated. Furthermore, co-extruding all three layers increases the miscibility between the polymeric materials of the second and third layers. However, depending on the ability of the third layer to expand with foamed polymeric material of the second layer, co-extruding the third layer with second layer may prevent the foamed polymeric material of the second layer from expanding or cause the third layer to burst upon the expansion of the foamed polymeric material. For such a tubing structure, it may be preferable to extrude the third layer after the foamed polymer material of the second layer has partially or fully expanded. The ability of the third layer to expand with the foamed polymeric material of the second layer would depend on polymeric material of the third layer and the thickness of the third layer. Therefore, for certain tubing structures it may be desirable to co-extrude all three layers and for other tubing structures it may be desirable to extrude the third layer after the foamed polymeric material has partially or fully expanded.

Following are examples of specific tube coating arrangements according to the present invention. These examples are provided for illustrative purposes only and are not intended, or to be construed, as limiting the scope of this invention.

### EXAMPLE 1

A steel tube was surface treated with a zinc-aluminum substrate. An inner layer comprised of PVF (polyvinyl fluoride) was bonded to the surface-treated steel tubing. An outer layer comprised of a polymer blend of polyamide and EPDM rubber was extruded over the inner layer. The outer layer was stripped at the ends of the tube to provide for end fittings or connections.

### EXAMPLE 2

A steel tube was surface treated with a zinc-aluminum substrate. An inner layer comprised of PVF was bonded to the surface-treated steel tubing. An outer layer comprised of a polymer blend of polyolefin and EPDM rubber was extruded over the inner layer. The outer layer was stripped at the ends of the tube to provide for end fittings or connections.

### EXAMPLE 3

A steel tube was surface treated with a zinc-aluminum substrate. An inner layer comprised of extruded nylon was bonded to the surface-treated steel tubing. An outer layer comprised of a polymer blend of polyolefin and EPDM rubber was extruded over the inner layer. The outer layer was stripped at the ends of the tube to provide for end fittings or connections.

### EXAMPLE 4

A steel tube was surface treated with a zinc-aluminum substrate. An inner layer comprised of extruded polyketone was bonded to the surface-treated steel tubing. An outer layer comprised of a polymer blend of polyamide and EPDM rubber was extruded over the inner layer. The outer layer was stripped at the ends of the tube to provide for end fittings or connections.

### EXAMPLE 5

A steel tube was surface treated with a zinc-aluminum substrate. An inner layer comprised of extruded polyketone was bonded to the surface-treated steel tubing. An outer layer comprised of a polymer blend of polyolefin and EPDM rubber was extruded over the inner layer. The outer layer was stripped at the ends of the tube to provide for end fittings or connections.

### EXAMPLE 6

A steel tube was surface treated with a zinc-aluminum substrate. An inner layer comprised of PVF was bonded to the surface-treated steel tubing. An outer layer comprised of a polymer blend of PVC (polyvinyl chloride) and nitrile rubber was extruded over the inner layer. The outer layer was stripped at the ends of the tube to provide for end fittings or connections.

### EXAMPLE 7

A steel tube was surface treated with a zinc-aluminum substrate. An inner layer comprised of PVF was bonded to the surface-treated steel tubing. An outer layer comprised of a polymer blend of PVC and nitrile rubber was extruded over the inner layer. The outer layer was stripped at the ends of the tube to provide for end fittings or connections.

### EXAMPLE 8

A steel tube was surface treated with a zinc-aluminum substrate. An inner layer comprised of PVF was bonded to the surface-treated steel tubing. An outer layer comprised of a copolymer of polyester thermoplastic elastomer was extruded over the inner layer. The outer layer was stripped at the ends of the tube to provide for end fittings or connections.

### EXAMPLE 9

A steel tube was surface treated with a zinc-aluminum substrate. An inner layer comprised of extruded nylon was bonded to the surface-treated steel tubing. An outer layer comprised of a copolymer of polyester thermoplastic elastomer was extruded over the inner layer. The outer layer was stripped at the ends of the tube to provide for end fittings or connections.

### EXAMPLE 10

A steel tube was surface treated with a zinc-aluminum substrate. An inner layer comprised of an epoxy was bonded to the surface-treated steel tubing. An outer layer comprised of a polymer blend of polyamide and EPDM rubber was extruded over the inner layer. The outer layer was stripped at the ends of the tube to provide for end fittings or connections.

### EXAMPLE 11

A steel tube was surface treated with a zinc-aluminum substrate. An inner layer comprised of an epoxy was bonded to the surface-treated steel tubing. An outer layer comprised of a polymer blend of polyolefin and EPDM rubber was extruded over the inner layer. The outer layer was stripped at the ends of the tube to provide for end fittings or connections.

### EXAMPLE 12

A steel tube was surface treated with a zinc-nickel substrate. An inner layer comprised of PVF was bonded to the surface-treated steel tubing. An outer layer comprised of a polymer blend of polyamide and EPDM rubber was extruded over the inner layer. The outer layer was stripped at the ends of the tube to provide for end fittings or connections.

### EXAMPLE 13

A steel tube was surface treated with a zinc-nickel substrate. An inner layer comprised of PVF was bonded to the surface-treated steel tubing. An outer layer comprised of a polymer blend of polyolefin and EPDM rubber was extruded over the inner layer. The outer layer was stripped at the ends of the tube to provide for end fittings or connections.

### EXAMPLE 14

A steel tube was surface treated with a zinc-nickel substrate. An inner layer comprised of extruded nylon was bonded to the surface-treated steel tubing. An outer layer comprised of a polymer blend of polyolefin and EPDM rubber was extruded over the inner layer. The outer layer was stripped at the ends of the tube to provide for end fittings or connections.

### EXAMPLE 15

A steel tube was surface treated with a zinc-nickel substrate. An inner layer comprised of extruded polyketone was bonded to the surface-treated steel tubing. An outer layer comprised of a polymer blend of polyamide and EPDM rubber was extruded over the inner layer. The outer layer was stripped at the ends of the tube to provide for end fittings or connections.

### EXAMPLE 16

A steel tube was surface treated with a zinc-nickel substrate. An inner layer comprised of extruded polyketone was bonded to the surface-treated steel tubing. An outer layer comprised of a polymer blend of polyolefin and EPDM rubber was extruded over the inner layer. The outer layer was stripped at the ends of the tube to provide for end fittings or connections.

### EXAMPLE 17

A steel tube was surface treated with a zinc-nickel substrate. An inner layer comprised of PVF was bonded to the surface-treated steel tubing. An outer layer comprised of a polymer blend of PVC and nitrile rubber was extruded over the inner layer. The outer layer was stripped at the ends of the tube to provide for end fittings or connections.

### EXAMPLE 18

A steel tube was surface treated with a zinc-nickel substrate. An inner layer comprised of PVF was bonded to the surface-treated steel tubing. An outer layer comprised of a copolymer of polyester thermoplastic elastomer was extruded over the inner layer. The outer layer was stripped at the ends of the tube to provide for end fittings or connections.

### EXAMPLE 19

A steel tube was surface treated with a zinc-nickel substrate. An inner layer comprised of extruded nylon was bonded to the surface-treated steel tubing. An outer layer comprised of a copolymer of polyester thermoplastic elastomer was extruded over the inner layer. The outer layer was stripped at the ends of the tube to provide for end fittings or connections.

### EXAMPLE 20

A steel tube was surface treated with a zinc-nickel substrate. An inner layer comprised of an epoxy was bonded to the surface-treated steel tubing. An outer layer comprised of a polymer blend of polyamide and EPDM rubber was extruded over the inner layer. The outer layer was stripped at the ends of the tube to provide for end fittings or connections.

### EXAMPLE 21

A steel tube was surface treated with a zinc-nickel substrate. An inner layer comprised of an epoxy was bonded to the surface-treated steel tubing. An outer layer comprised of a polymer blend of polyolefin and EPDM rubber was extruded over the inner layer. The outer layer was stripped at the ends of the tube to provide for end fittings or connections.

### EXAMPLE 22

A steel tube was surface treated with a zinc-aluminum substrate. An inner layer comprised of extruded polyamide was bonded to the surface-treated steel tubing. An outer layer comprised of a foamed copolymer of polyester thermoplastic elastomer was extruded over the inner layer. The outer layer was stripped at the ends of the tube to provide end fittings or connections.

### EXAMPLE 23

An inner layer comprised of extruded polyamide was bonded to the surface of an aluminum tubing. An outer layer comprised of a foamed polyamide was extruded over the inner layer. The outer layer was stripped at the ends of the tube to provide end fittings or connections.

### EXAMPLE 24

A layer comprised of a foamed polyamide was extruded over the surface of an aluminum tubing. The layer of foamed polyamide was stripped at the ends of the tube provide end fittings or connections.

### EXAMPLE 25

A steel tube was surface treated with a zinc-nickel substrate. A layer comprised of an epoxy was bonded the surface-treated steel tubing. An outer layer comprised of a foamed polymer blend of polyamide and EPDM rubber was extruded over the layer of epoxy.

### EXAMPLE 26

A steel tube was surface treated with a zinc-nickel substrate. An inner layer comprised of PVF was bonded to the surface-treated steel tubing. An outer layer comprised of foamed polyamide was extruded over the inner layer.

### EXAMPLE 27

An inner layer comprised of non-foamed polyketone was extruded directly onto an aluminum tube. An outer layer comprised of foamed polyamide was co-extruded around the inner layer of non-foamed polyuketone.

### EXAMPLE 28

A steel tube was surface treated with a zinc-aluminum substrate. An inner layer comprised of non-foamed polyketone was extruded directly onto the zinc-nickel substrate. An outer layer comprised of foamed polyamide was co-extruded around the inner layer of non-foamed polyuketone.

### EXAMPLE 29

A steel tube was surface treated with a zinc-nickel substrate. An inner layer comprised of non-foamed polyurethane was extruded directly onto the zinc-nickel substrate. An outer layer comprised of foamed polyurethane was co-extruded around the inner layer of non-foamed polyurethane.

### EXAMPLE 30

An inner layer comprised of non-foamed polyamide was extruded directly onto an aluminum tube. An outer layer comprised of foamed polyamide was co-extruded around the inner layer of non-foamed polyamide.

### EXAMPLE 31

An inner layer comprised of non-foamed polyethylene was extruded directly onto an aluminum tube. An intermediate layer comprised of foamed polyethylene was co-extruded around the inner layer of non-foamed polyethylene. An outer layer comprised of non-foamed polyamide was co-extruded around the intermediate layer of foamed polyethylene.

### EXAMPLE 32

An inner layer comprised of non-foamed polyamide was extruded directly onto an aluminum tube. An intermediate layer comprised of foamed polyamide was co-extruded around the inner layer of non-foamed polyamide. After the foamed polyamide has partially or fully expanded, an outer layer comprised of non-foamed polyamide was extruded around the intermediate layer of foamed polyamide.

### EXAMPLE 33

A steel tube was surface treated with a zinc-nickel substrate. An inner layer comprised of non-foamed polyurethane was extruded directly onto the zinc-nickel substrate. An intermediate layer comprised of foamed polyurethane was co-extruded around the inner layer of non-foamed polyamide. An outer layer comprised of non-foamed polyurethane was co-extruded around the intermediate layer of foamed polyamide.

### EXAMPLE 34

A steel tube was surface treated with a zinc-nickel substrate. An inner layer comprised of non-foamed polyamide was extruded directly onto the zinc-nickel substrate. An intermediate layer comprised of foamed polyamide was co-extruded around the inner layer of non-foamed polyamide. After the foamed polyamide has partially or fully expanded, an outer layer comprised of non-foamed polyamide was extruded around the intermediate layer of foamed polyamide.

Various features of the present invention have been described with reference to the embodiments shown and described. It should be understood, however, that modification may be made without departing from the spirit and scope of the invention as represented by the following claims.

1. A coated metal tubing arrangement comprising:
a metal tube;
a first layer of a first polymeric material;
a second layer of a second polymeric material having a foamed structure and located directly radially outwardly of said first layer, said second polymeric material is chemically similar to said first polymeric material.

2. The coated metal tubing arrangement as claimed in claim 1 wherein said second polymeric material comprises said first polymeric material and a blowing agent.

3. The coated metal tubing arrangement as claimed in claim 1 wherein said second polymeric material of said second layer is miscible with said first polymeric material of said first layer.

4. The coated metal tubing arrangement as claimed in claim 1 wherein said first polymeric material is selected from the group consisting of polyamides, polyesters, polyolefins, polyurethane, polyethylene and polyvinyl chloride and mixtures thereof.

5. The coated metal tubing arrangement as claimed in claim 2 wherein said blowing agent is selected from the group consisting of azodicarbonamides, hydrazine derivatives, semi-carbazides, tetrazoles, benzoxazines and mixtures thereof.

6. The coated metal tubing arrangement as claimed in claim 1 further comprising a third layer of said first polymeric material directly radially outwardly of said second layer.

7. The coated metal tubing arrangement as claimed in claim 6 wherein said first polymeric material of said third layer is miscible with said second polymeric material of said second layer.

8. The coated metal tubing arrangement as claimed in claim 1 wherein said metal tubing is form of aluminum.

9. The coated metal tubing arrangement as claimed in claim 1 wherein said metal tubing is formed of steel.

10. The coated metal tubing arrangement as claimed in claim 1 wherein said metal tubing was surface treated with a substrate.

11. A method for forming a coated metal tubing arrangement comprising the steps of:
providing a metal tubing;
providing a first polymeric material;
extruding said first polymeric material directly onto said metal tubing;
providing a second polymeric material;
co-extruding said second polymeric material radially outwardly of said first polymeric material; and
expanding said second polymeric material to form a foamed structure.

12. The method as claimed in claim 11 further comprising the step of adding a blowing agent to said second polymeric material.

13. The method as claimed in claim 12 wherein said blowing agent is selected from the group consisting of azodicarbonamides, hydrazine derivatives, semi-carbazides, tetrazoles, benzoxazines and mixtures thereof.

14. The method of claimed in claim 11 further comprising the step of injecting gas into said second polymeric material.

15. The method as claimed in claim 11 wherein said first polymeric material is not chemically similar to said second polymeric material.

16. The method as claimed in claim 11 wherein said first polymeric material is chemically similar to said second polymeric material.

17. The method as claimed in claim 16 wherein said second polymeric material comprises said first polymeric material and a blowing agent.

18. The method as claimed in claim 11 further comprises the steps of providing a third polymeric material and extruding said third polymeric material radially outwardly of said first polymeric material.

19. The method as claimed in claim 18 wherein said third polymeric material is chemically similar to said second polymeric material.

20. The method as claimed in claim 18 wherein said third polymeric material is co-extruded with said second polymeric material.

21. The method as claimed in claim 18 wherein said third polymeric material is extruded after said second polymeric material has partially or fully expanded to a foamed structure.
